(19) United States
(12) Patent Application Publication
(10) Pub. No.: US 2016/0236088 A1
(43) Pub. Date: Aug. 18, 2016

(54) PROVISION OF A VIRTUAL ENVIRONMENT BASED ON REAL TIME DATA

(71) Applicants: Hong C. LI, El Dorado Hills, CA (US); Igor Tatourian, Santa Clara, CA (US); Rita H. Wouhaybi, Portland, OR (US); Tobias M. Kohlenberg, Portland, OR (US)

(72) Inventors: Hong C. Li, El Dorado Hills, CA (US); Igor Tatourian, Santa Clara, CA (US); Rita H. Wouhaybi, Portland, OR (US); Tobias M. Kohlenberg, Portland, OR (US)

(21) Appl. No.: 14/364,294

(22) PCT Filed: Dec. 23, 2013
(86) PCT No.: PCT/US2013/077611

§ 371 Date: Jun. 10, 2014

(51) Int. Cl. A63F 13/655; A63F 13/26; H04L 29/06

(52) U.S. Cl. CPC A63F 13/655; H04L 67/38; A63F 13/26

(57) ABSTRACT

Apparatus, computer-readable storage medium, and method associated with provision of a virtual environment. In embodiments, a computing apparatus may include a processor and a virtualization module. The virtualization module may be operated by the processor to provide the virtual environment, based at least in part on real time data of a physical environment virtualized in the virtual environment. In embodiments, the computing apparatus may further include a physical environment module. The physical environment module may be operated by the processor to acquire the real time data of the physical environment for the virtualization module. Other embodiments may be described and/or claimed.

### TECHNICAL FIELD

Embodiments of the present disclosure are related to the field of virtualization, and in particular, to provisioning of a virtual environment based upon real time data.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Video games and simulations increasingly employ virtual environments that emulate physical environments. Under the current state of the art, however, such virtual environments are limited to preprocessed versions of the physical environments captured at particular points in time. For example, the game “Flight Simulator” provides for virtualized scenes of New York City (NYC), as a player “flies” into John F. Kennedy Airport. The virtualized scenes of NYC are based on scenes of NYC captured a point in time prior to the release of the game. Thus, until the game is updated, the game continues to show the virtualized scenes of NYC with the collapsed World Trade Center.

### BRIEF DESCRIPTION OF THE DRAWINGS

FIG. 1 depicts an illustrative environment in which some embodiments of the present disclosure may be practiced.

FIG. 2 depicts illustrative virtual environments incorporating real time data according to some embodiments of the present disclosure.

FIG. 3 depicts an illustrative time shifted virtual environment incorporating real time data.

FIG. 4 depicts an illustrative process flow of a physical environment module according to some embodiments of the present disclosure.

FIG. 5 depicts an illustrative process flow of a virtualization module according to some embodiments of the present disclosure.

FIG. 6 depicts an illustrative computing device, according to some embodiments of the present disclosure.

### DETAILED DESCRIPTION OF ILLUSTRATIVE EMBODIMENTS

A method, storage medium, and computing apparatus for provision of a virtual environment based on real time physical environment data are some embodiments described herein. In embodiments, the computing apparatus may include a processor; a virtualization module operated by the processor to provide the virtual environment, based at least in part on real time data of a physical environment virtualized in the virtual environment; and a physical environment module operated by the processor to acquire the real time data of the physical environment for the virtualization module. In embodiments, the real time data may be images or a video feed from one or more sensors, such as a camera, in the physical environment. The virtualization module may incorporate a portion of the images or video feed into the virtual environment. In some embodiments, the virtual environment may be an interactive user environment, such as a game or simulation and the computing apparatus may be a video game console.

In the following detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C). The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

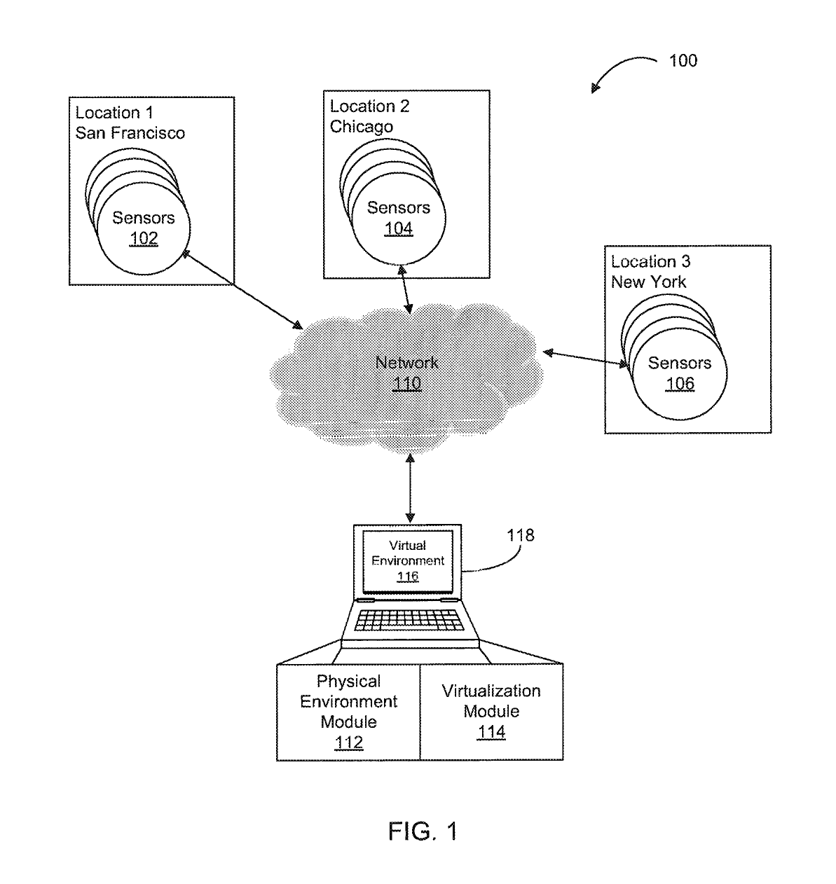

FIG. 1 depicts an illustrative environment in which some embodiments of the present disclosure may be practiced. As depicted, sensors 102-106 may collect real time data from locations 1-3, respectively, and may stream, or periodically transmit, the real time data into network 110. Sensors 102-106 may be disposed at locations 1-3, e.g., integrated with infrastructures, such as street signs, traffic lights, at the locations, or may be disposed on terrestrial or aerial vehicles that travel through locations 1-3. Physical environment module 112 may acquire, via network 110, at least a portion of the real time data for use by virtualization module 114. Virtualization module 114 may incorporate the real time data into virtual environment 116 representing the one or more locations. For example, virtual environment 116 may be a video game or simulation taking place in New York City. In such an example, physical environment module 112 may be configured to acquire real time data, such as, for example, images and audio, from sensors 106 located in New York City for use by virtualization module 114. Virtualization module 114 may be configured to integrate the real time images and audio into the video game or simulation depicted in virtual environment 116, thereby potentially enhancing user experience.

As used herein, real time data may refer to data collected and streamed for output contemporaneously as the data is produced by sensors 102-106, this time period may take into account any processing the sensor may apply to the data. Real time data may also refer to data collected and processed through one or more processing steps, such as those described herein below, prior to being output. As a result, the real time data may not be instantaneously reflected in the virtual environment, but may rather be delayed by the processing of the real time data to prepare the data for transmission and/or production of the data in the virtual environment. In addition, the real time data may refer to data captured at various time intervals. For instance, to reduce the amount of bandwidth used in transmitting the real time data, the real time data may be updated at certain time intervals, e.g., updated every 30 seconds, 5 minutes, etc. It will be appreciated that the time interval may be dependent upon how frequently the real time data changes. For example, producing real time data of driving in downtown New York City, as described above, may need to be updated more often to reflect the rapidly changing nature of traffic in New York City than real time data reflecting a a drive in a rural area in the Midwest. In addition, sensors 102-106 may be configured to update the real time data as changes occur. For example, if a sensor is monitoring temperature of the real time environment, that sensor may be configured to send an update only upon a change in the temperature or upon a change in the temperature above a preset threshold, e.g., when the temperature changes by 5 degrees. It will be appreciated that the examples provided above are merely meant to be illustrative and should not be taken as limiting of this disclosure.

Physical environment module 112 may, in some embodiments, be configured to acquire real time data collected and/or generated by sensors 102-106, for virtualization module 114. In some embodiments, physical environment module 112 may be configured to send a request to a service in network 110, not depicted herein, that may be configured to route appropriate real time data acquired by sensors 102-106 to physical environment module 112. In other embodiments, physical environment module 112 may be configured to acquire the real time data by sending a request directly to a computing device incorporating appropriate sensors. For example, in some embodiments, network 110 may be a peer-to-peer network in which computing device 118 may be a node. In such an embodiment, the sensors may be incorporated into computing devices forming additional nodes of the peer-to-peer network such that physical environment module 112 may send a request directly to an appropriate node to acquire needed real time data. In other embodiments, sensors 102-106 may be associated with computing devices/services from which physical environment module 112 may subscribe, and receive continuous or periodic streaming of real time data from the collecting sensors. In other embodiments, not depicted, the physical environment module 112 may not be implemented on computing device 118, but may rather be implemented in network 110 and may be configured to service the requests of multiple virtualization modules, such as virtualization module 114. This may be accomplished, for example, by the physical environment module 112 being configured to receive requests for real time data from individual virtualization modules and providing appropriate real time data in response.

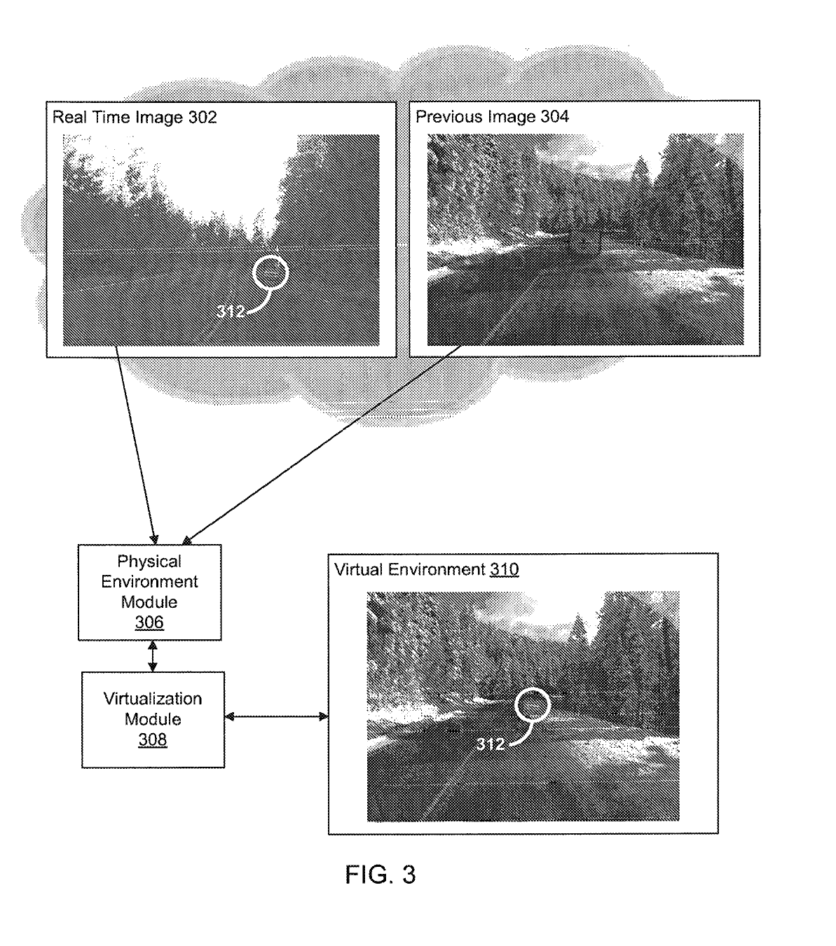

Virtualization module 114 may be configured to receive real time data from the physical environment module 112 and may be configured to process the real time data for integration into virtual environment 116 provided by virtualization module 114. Virtualization module may be configured to receive inputs from a user and correlate those inputs with movements of the user in the virtual environment 116. Further, as the user moves through virtual environment 116, virtualization module 114 may request additional real time data from physical environment module 112 to be incorporated into virtual environment 116 to reflect such movement. Virtualization module 114 may also be configured to integrate data previously collected and stored with real time data to effectuate a time shifting of the real time data, this is discussed further in reference to FIG. 3, below.

In some embodiments, virtual environment 116 may be an interactive virtual environment such as a video game or interactive simulation occurring within the physical environment from which the real time data may originate. In other embodiments, virtual environment 116 may not be interactive and may enable a user of the virtualization module to monitor aspects of the real time data that may be integrated into virtual environment 116 with one or more virtual features incorporate therein. For example, virtual environment 116 may be generated for a parent to monitor a child's driving in real time without being physically in a vehicle with the child. In such embodiments, virtualization module 114 may be configured to incorporate virtual features highlighting aspects of the child's driving for the parent into virtual environment 116 along with real time data, such as speed, location, direction of travel, etc. Such highlighted aspects may include, for example, dangerous conditions created by the child or another driver. This same embodiment may be extended to employers who hire drivers, such as delivery drivers or truck drivers, for the employer to keep tabs of an employee's driving through virtual environment 116.

Sensors 102-106, may be any type or combination of sensors including physical sensors and/or virtual/soft sensors. Physical sensors may include, but are not limited to, cameras, microphones, touch sensors, global positioning systems (GPS), accelerometers, gyroscopes, altimeters, temperature sensors, pressure sensitive sensors, vibration sensors, or signal related sensors, such as infrared, Bluetooth, or Wi-Fi. Virtual/soft sensors may include sensors that develop data indirectly for example, a location sensor that utilizes map information and knowledge of wireless network signal signatures, such as Wi-Fi, along with the strength of the signal to determine a user's location. These examples are not meant to be exhaustive and are merely meant to provide a sampling of possible sensors. Any sensor capable of producing data that may be used by a computing device is contemplated. In some embodiments, each sensor may collect an associated form of data and provide it to network 110. In some embodiments, the sensors may provide data to network 110 in real time when requested by a physical environment module 112. In other embodiments, the data may be automatically sent to network 110 in real time where the data may be provided to a physical environment module in real time and may additionally be stored in a repository of network 110.

In embodiments, sensors 102-106 may be incorporated into vehicles, such as cars, buses, planes, boats, etc. such that the real time data provided to network 110 may enable virtual environments depicting the driving or piloting of these vehicles in the physical environment of the sensors in real time. In other embodiments, the sensors may be integrated with a portable computing device such as a smart phone, tablet, laptop or wearable computing devices such as, for example, Google Glass. Such sensors may enable a virtual environment depicting additional activities such as hiking, shopping, sightseeing, etc. In some embodiments, sensors 102-108 may include stationary sensors such as, for example, web/municipal/traffic cameras, weather related sensors, such as temperature, barometric pressure, and precipitation, or any other stationary sensor that may provide the requisite real time data. For instance, if a shopping experience is being depicted a data feed from the cameras of a local department store may be acquired by physical environment 112. This data feed may be provided to virtualization module 114 which may then integrate portions of the captured images into virtual environment 116.

In some embodiments, devices or vehicles incorporating sensors 102-106, or a portion thereof, may be controlled by other users of the virtual environment willing to share real time data collected by such users. In such embodiments, the user may be able to restrict access to the real time data such that the user's identity may be obfuscated. For example, the user may set global positioning satellite (GPS) coordinates defining a boundary outside of which the user may not wish to share real time data, for example the user may define a boundary just outside of a residential area in which they reside. In embodiments where the sensors are incorporated into a vehicle, a service in network 110, not depicted, may act to limit access to data based upon the number of users that travel a certain route and may only allow access to routes having a predetermined number of users travelling on those routes.

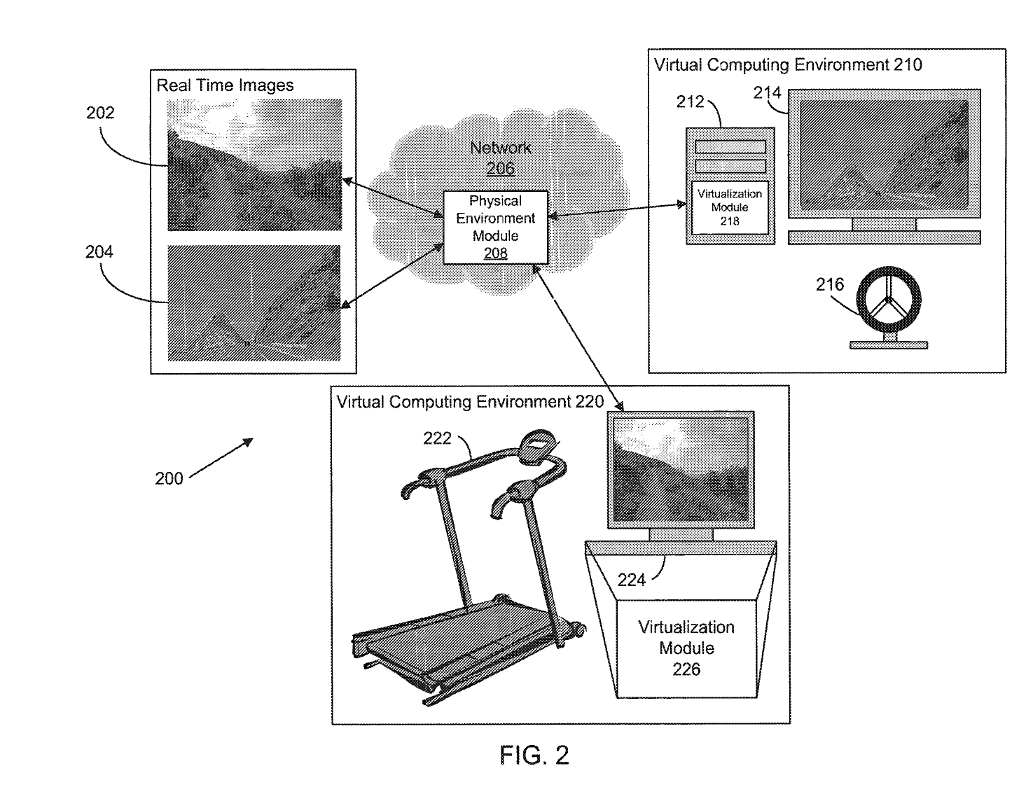

As depicted locations 1-3 may be different geographic locations having sensors for providing real time data. While depicted as major metropolitan areas, these locations may be much more granular, such as those locations depicted in FIGS. 2 and 3, below. While only 3 locations are depicted herein, this is merely for illustrative purposes and any number of locations may be incorporated without departing from the scope of this disclosure.

Network 110 may be any type or combination of wired or wireless network, including, but not limited to, local area networks (LANs), wide area networks (WANs), cellular networks, peer-to-peer networks, and the internet. Any network suitable for transmitting the requisite data may be used without departing from the scope of this disclosure. Furthermore, network 110 may include a plurality of wired and/or wireless networks that may be used in combination without departing from the scope of this disclosure. This disclosure is equally applicable regardless of type and/or composition of the network.

FIG. 2 depicts a system 200 according to embodiments of the present disclosure. System 200 may include one or more sensors, not depicted, such as sensors 102-106 of FIG. 1. The sensors may capture real time images and/or video, such as images/video streams 202 and 204, hereinafter referred to as images 202 and 204 for simplicity, and may be coupled with network 206 to enable real time images 202 and 204, as well as other real time data, to be transmitted and/or stored to network 206.

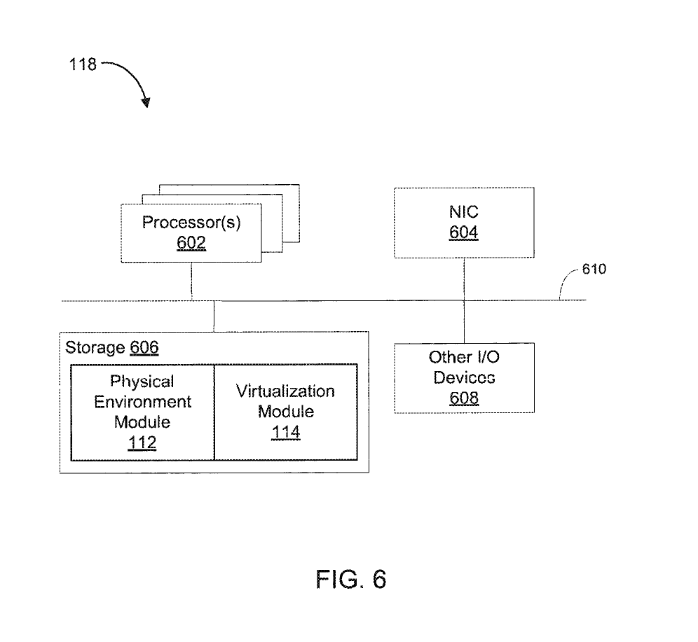

System 200 may include virtual computing environment 210 having computing device 212, display 214 and one or more components for user input, e.g., steering wheel 216. In embodiments, computing device 212 may include a virtualization module 218, similar to that described in FIG. 1 above. As depicted, virtual computing environment 210 may be utilized for a virtual driving experience, or a game. In embodiments, virtualization module 218 may be communicatively coupled with physical environment module 208 and configured to request real time data from physical environment module 208 to integrate with a virtual environment, herein depicted as a driving simulation. In some embodiments, as depicted, physical environment module 208 may be configured to reside on network 206. In other embodiments, as depicted in FIGS. 1 and 6, physical environment module 208 may be configured to reside on computing device 212. In response to the request, physical environment module 208 may acquire real time data, such as real time image 204, for virtualization module 218 to integrate into the virtual environment. In some embodiments, the virtual computing environment may include an actual vehicle for user input, such as a plane, car, bus, power boat, kayak, etc. Such actual vehicles may be utilized, in addition to the real time data, to make the virtual environment more realistic and may also enable things like a virtual trial of any such vehicle without leaving the store or even more realistic training for pilots, bus drivers, police officers, etc.

Virtualization module 218, upon receiving the real time data, may integrate portions of the real time data into the virtual environment. As depicted by display 214, this integration may include integration of real time image 204 into the virtual environment. In embodiments, virtualization module 218 may be further configured to integrate additional portions of real time data into the virtual environment. For instance, virtualization module 218 may take into account real time temperature, elevation, and wind of the physical environment in determining acceleration, deceleration, or tracking of a car in the virtual environment. Furthermore, virtualization module 218 may be communicatively coupled with one or more additional devices, such as steering wheel 216, to provide additional sensory feedback to the user. For example, the real time data may contain information on the road surface of the physical environment, e.g., potholes, road irregularities, etc., and virtualization module 218 may integrate this road surface information into the virtual environment through vibration of the steering wheel.

While the image produced on display 214 is depicted as an exact integration of real time image 204, the image, need not be integrated exactly. For instance, virtualization module 218 may be configured to integrate only the background imagery of real time image 204 and may be configured to add and/or remove features, such as, for example, vehicles, pedestrians, plants and animals, to/from the virtual environment. This may be accomplished, in some embodiments, by taking a two-dimensional (2-D) real time image provided by physical environment module 208 and generating a three-dimensional (3-D) rendering therefrom. The 3-D rendering may then be manipulated to add and/or remove the features from the real time image for integration into the virtual environment. It will be appreciated that the addition and/or removal of features is not limited to images and may be integrated with other real time data, such as adding and/or removing sounds from real time audio. This disclosure is not to be limited based upon what may be added, removed, modified or manipulated from the real time data. In some embodiments, virtual environment module may be configured to extract the 2-D image from real time video provided by physical environment module 208. In other embodiments, virtualization module 218 may not be configured to modify the real time data, but rather may be communicatively coupled with one or more components capable of such modification, such as, for example, utilizing a library, e.g., OpenCV, to manipulate real time images.

System 200 may also include virtual computing environment 220 having display 224 and one or more components for user input, e.g., treadmill 222. In embodiments, display 224 may also be a computing device having a virtualization module 226, similar to the virtualization modules described above, integrated therein. As depicted, virtual computing environment 220 may be utilized for a virtual trail running or hiking experience, or a game depicting such an activity. In embodiments, virtualization module 226 may be communicatively coupled with physical environment module 208 and may be configured to request real time data from physical environment module 208 to integrate with the virtual environment. In response to the request, physical environment module 208 may acquire real time data, such as real time image 202, for virtualization module 226 to integrate into the virtual environment.

Virtualization module 226, upon receiving the real time data, may be configured to integrate portions of the real time data into the virtual environment. As depicted by display 224, this integration may include integration of real time image 202 into the virtual environment. In embodiments, virtualization module 226 may be further configured to integrate additional portions of real time data into the virtual environment. Furthermore, virtualization module 226 may be communicatively coupled with one or more additional devices, such as treadmill 222, to provide additional sensory feedback to the user. For example, the real time data may contain information on elevation changes of the physical environment collected in real time and virtualization module 226 may integrate these elevation changes into the virtual environment by adjusting the elevation of treadmill 222 to correspond with these changes.

While the image produced on display 224 is depicted as an exact integration of real time image 202, as discussed above, the image need not be integrated exactly. For instance, virtualization module 226 may be configured to integrate only the background imagery of real time image 202 and may be configured to add and/or remove features, such as, for example, other hikers/runners, plants and animals, to/from the virtual environment. This may be accomplished, as discussed above, by converting the 2-D image received from physical environment module 208, into a 3-D rendering. The 3-D rendering may then be manipulated to add and/or remove the features from the real time image for integration into the virtual environment.

It will be appreciated that the two virtual environments depicted in FIG. 2 are meant to merely be illustrative examples of possible virtual environments. Other possibilities include, but are not limited to, boating, flying, shopping, skiing, etc. or any video games or simulations depicting such activities. The type of activity is not to be limiting of this disclosure and any virtual environment incorporating real time data is specifically contemplated regardless of the type of activity.

In some embodiments, a user of virtual computing environments 210 or 220 may be able to select from a list of locations that currently have real time data available. For example, if there is real time data currently being sent to network 206 from 100 different locations, the user may be able to select from any one of those locations. In other embodiments, the user may be able to select from locations having real time data available and those that have had real time data previously recorded and saved into network 206. In such embodiments, the user may be informed that real time data is not available for all locations and those locations having real time data may be distinguished in some manner from those locations that would utilize saved data rather than real time data. In such embodiments, physical environment module 208 may be configured to gather a list of the different locations with available data and transmit the list to virtualization modules 218 and 226 for presentation of and selection by the user.

In some embodiments the virtual environment may be an interactive virtual environment. In such embodiments, the virtualization module, e.g., virtualization module 218 or 226, may be configured to move the user through the virtual environment based upon inputs received from the user. In such embodiments, the virtualization module, e.g., virtualization module 218 or 226, may be configured to request additional real time data from physical environment module 208. The virtualization module may then integrate the additional real time data into the virtual environment. For example, consider virtual computing environment 210, if a user proceeds down the road or turns to take a different path additional real time data may be necessary to reflect such movement. In some embodiments, a user's movements may be limited to those paths currently having real time data available. For example, virtualization module 218 may not allow the user to turn down a road that does not have real time data available. In other embodiments, a user may be able to select a path so long as there is either real time data available or previously stored data available. For example, virtualization module 218 may allow a user of virtual computing environment 210 to turn onto a road that does not currently have real time data available if previously recorded data of the road is available. In such embodiments, virtualization module 218 may be configured to splice the previously recorded data into the virtual environment without impeding the users progress in the virtual environment.

In some embodiments, the user may wish to have a virtual environment based upon real time data, but may wish to time shift the environment so that the virtual environment appears to take place at different time. For example, if a user wishes to have a real time virtual environment simulating skiing at Whistler, but it is the middle of July, the virtualization module, e.g., virtualization module 308 of FIG. 3, may be configured to time shift the real time data such that the virtual environment may reflect such a time shift. In some embodiments, this time shift may be accomplished utilizing previously collected data integrated with the real time data to reflect the time or weather that the user wishes.

FIG. 3 depicts an illustrative time shifted virtual environment 310 incorporating real time data, e.g., real time image 302, and previously collected data, e.g., previous image 304. In such an embodiment, virtualization module 308, similar to virtualization modules 114, 218 and 226 discussed above in reference to FIGS. 1 and 2, may be configured to present the user with a list of available locations having real time data available and once a location is selected may be configured to provide a list of possible time shifting for the selected location. Once selected, virtualization module 308 may be configured to request the location and time shift data from physical environment module 306, similar to physical environment modules 112, 218 and 226 discussed above in reference to FIGS. 1 and 2. Physical environment module 306 may retrieve the requested location and time shift data and may provide this data to virtualization module 308. Virtualization module 308 may then incorporate aspects of the time shift data into the real time location data. As depicted, virtual environment 310 consists of real time image 302 with the weather of previous image 304 superimposed onto real time image 302. This is evidenced by car 312 located on the side of the road in both real time image 302 and virtual environment 310. In some embodiments, previously recorded data may not be necessary and virtualization module may be configured to apply different weather conditions and/or lighting to the virtual environment by merely virtualizing such weather conditions or lighting onto the real time image.

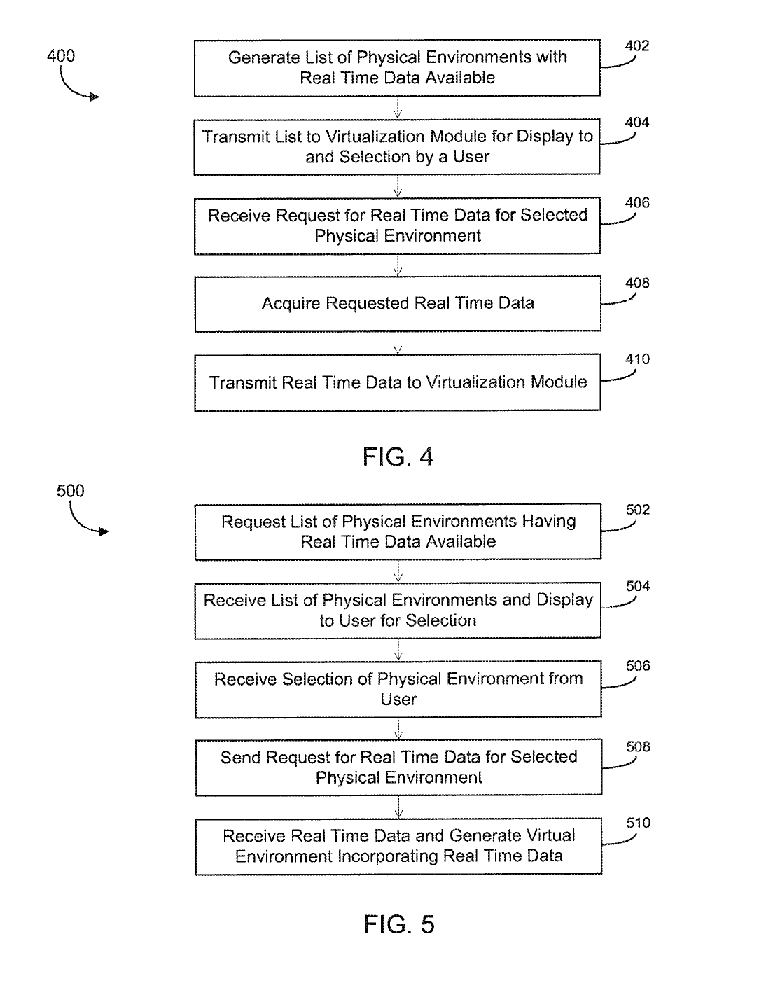

FIG. 4 depicts an illustrative process flow 400 associated with a physical environment module according to some embodiments of the present disclosure. Process 400 may begin at procedure 402 where a list of physical environments with available real time data may be generated. This may be accomplished, in some embodiments, by polling individual devices which have sensors capturing the real time data and generating a list of the physical environments associated therewith. In other embodiments, a listing of devices which have sensors capturing the real time data may be dynamically updated as the devices come online or go offline. The physical environment associated with a device which has sensors capturing real time data may be determined based upon a geographic location identifier, such as, for example global position satellite (GPS) coordinates or other method of geolocation. In some embodiments, access to real time data of physical environments may be limited depending upon one or more factors. For instance, there may be different levels of subscription for the real time data that may enable access to increasing levels of real time data. As another example, the user may have a device for collecting and sharing real time data with other users and the more real time data the user shares the more levels of real time data the user may have access to. These different levels of real time data may be sensor based, for example the user may be able to access real time camera feeds, but may not be able to access some of the other sensor data, e.g. audio. In other embodiments, these different levels may be location based. For instance the user may have access to major metropolitan areas, but may not have access to other areas with more limited data that may be more expensive to acquire. These restrictions may be taken into account when gathering the list of physical environments with available real time data.

In procedure 404 the list of physical environments with available real time data may be transmitted to a virtualization module for the virtualization module to display the list to a user of the virtualization module for selection of a physical environment. Once selected, the physical environment module may receive a request for real time data associated with the selected physical environment. This request may include credentials of the user to enable and/or limit access to the real time data feeds and an identifier of requested data. For example, the user may merely want a virtual environment reflecting real time scenery of the physical environment and thus only an image or video feed may be requested. Such real time data options may be presented to the user with the list of available real time data for selection by the user. The request may also include a request for time shifting of the virtual environment, as discussed above in reference to FIG. 3.

In procedure 408, the physical environment module may acquire the requested real time data. This may be accomplished, as discussed above, by directly accessing devices collecting the real time data or by requesting such data from a service that aggregates the real time data for access by the physical environment module. In embodiments where a time shift is requested, the physical environment module may also acquire previously collected sensory data that may be integrated with the real time data to reflect the time shift. In procedure 410, the acquired data may be transmitted to a virtualization module for incorporation into a virtual environment.

FIG. 5 depicts an illustrative process flow 500 of a virtualization module according to some embodiments of the present disclosure. In procedure 502 the virtualization module may request a list of physical environments having real time data available. As discussed above in FIG. 4, access to the real time physical environment data may be limited depending upon one or more factors. In some embodiments, this access may be restricted depending upon the user and, in such embodiments, credentials capable of identifying the user and/or verifying access may be transmitted as a part of this request.

In procedure 504 the list of physical environments may be received by the virtualization module and may be presented to the user for selection and in procedure 506 a user selection may be received. In 508 a request for the selected real time data may be sent to a physical environment module. In procedure 510 the virtualization module may receive the requested real time data and may incorporate the real time data into a virtual environment.

FIG. 6 depicts a composition of computing apparatus 118 of FIG. 1, according to some embodiments of the present disclosure. Computing device 118 may comprise processor(s) 602, network interface card (NIC) 604, storage 606, containing physical environment module 112 and virtualization module 112, and other I/O devices 612. Processor(s) 602, NIC 604, storage 606, and other I/O devices 612 may all be coupled together utilizing system bus 610.

Processor(s) 602 may, in embodiments, be comprised of one or more single core and/or one or more multi-core processors, or any combination thereof. In embodiments with more than one processor the processors may be of the same type, i.e. homogeneous, or they may be of differing types, i.e. heterogenous. This disclosure is equally applicable regardless of type and/or number of processors.

In embodiments, NIC 604 may be used by computing device 118 to access a network, such as network 110 of FIG. 1. In embodiments, NIC 604 may be used to access a wired or wireless network; this disclosure is equally applicable. NIC 604 may also be referred to herein as a network adapter, LAN adapter, or wireless NIC which may be considered synonymous for purposes of this disclosure, unless the context clearly indicates otherwise; and thus, the terms may be used interchangeably.

In embodiments, storage 606 may be any type of computer-readable storage medium or any combination of differing types of computer-readable storage media. Storage 606 may include volatile and non-volatile/persistent storage. Volatile storage may include e.g., dynamic random access memory (DRAM). Non-volatile/persistent storage 606 may include, but is not limited to, a solid state drive (SSD), a magnetic or optical disk hard drive, flash memory, or any multiple or combination thereof.

In embodiments, physical environment module 112 and/or virtualization module 114 may be implemented as software, firmware, or any combination thereof. In some embodiments, physical environment module 112 and virtualization module 114 may, respectively, comprise one or more instructions that, when executed by processor(s) 602, cause computing device 118 to perform one or more operations of the process described in reference to FIGS. 4 and 5, above, or any other processes described herein in reference to FIGS. 1-3. In other embodiments computing device 118 may take the form of, for example, a smartphone, computing tablet, ultrabook, laptop computer, e-reader, e-book, game console, set-top box, etc.

For the purposes of this description, a computer-usable or computer-readable medium can be any medium that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Embodiments of the disclosure can take the form of an entirely hardware embodiment, an entirely software embodiment or an embodiment containing both hardware and software elements. In various embodiments, software, may include, but is not limited to, firmware, resident software, microcode, and the like. Furthermore, the disclosure can take the form of a computer program product accessible from a computer-usable or computer-readable medium providing program code for use by or in connection with a computer or any instruction execution system.

Although specific embodiments have been illustrated and described herein, it will be appreciated by those of ordinary skill in the art that a wide variety of alternate and/or equivalent implementations may be substituted for the specific embodiments shown and described, without departing from the scope of the embodiments of the disclosure. This application is intended to cover any adaptations or variations of the embodiments discussed herein. Therefore, it is manifestly intended that the embodiments of the disclosure be limited only by the claims and the equivalents thereof.

### EXAMPLES

Some non-limiting examples are:

Example 1 is a computing apparatus for provision of a virtual environment comprising: a processor; a virtualization module operated by the processor to provide the virtual environment for output to one or more output devices, based at least in part on real time data of a physical environment virtualized in the virtual environment; and a physical environment module operated by the processor to receive the real time data of the physical environment for the virtualization module.

Example 2 may include the subject matter of Example 1, wherein the virtual environment is an interactive virtual environment and the virtualization module is further to enable movement of a user in the virtual environment in response to inputs of the user received by the computing apparatus.

Example 3 may include the subject matter of Example 2, wherein to enable movement of a user is further to enable movement of the user based upon conditions reflected in the real time data.

Example 4 may include the subject matter of Example 3, wherein the virtualization module is to request from the physical environment module additional real time data based upon the movement of the user and the physical environment module is to acquire, in response to the request, the additional real time data, wherein the virtual environment is updated at least in part on the additional real time data.

Example 5 may include the subject matter of Example 1, wherein the real time data includes one or more two dimensional (2-D) images of the physical environment and the virtualization module is further to generate three-dimensional (3-D) renderings from the 2-D images and wherein the virtual environment is based at least in part the 3-D renderings.

Example 6 may include the subject matter of Example 4, wherein the virtualization module is further to apply virtualized lighting conditions to the 3-D renderings to provide a time shifted virtual environment.

Example 7 may include the subject matter of Example 6, wherein the virtualized lighting conditions are based, at least in part, on previously collected data of the physical environment and the physical environment module is further to acquire the previously collected data for the virtualization module.

Example 8 may include the subject matter of Example 4, wherein the virtualization module is further to apply virtualized weather conditions to the 3-D renderings to provide a time shifted virtual environment.

Example 9 may include the subject matter of Example 8, wherein the virtualized weather conditions are based, at least in part, on previously collected data of the physical environment and the physical environment module is further to acquire the previously collected data for the virtualization module.

Example 10 may include the subject matter of any one of Examples 1-9, wherein the real time data of the physical environment is collected by one or more sensors in the physical environment.

Example 11 may include the subject matter of any one of Examples 1-9, wherein the real time data reflects driving conditions, boating conditions or flying conditions.

Example 12 may include the subject matter of any one of Examples 1-9, wherein the real time data includes one or more of video, audio, global positioning satellite (GPS) coordinates, speed, acceleration, deceleration, lighting, temperature, or direction of travel.

Example 13 may include the subject matter of any one of Examples 1-9, wherein to receive the real time data is further to acquire the real time data from the physical environment.

Example 14 may include the subject matter of any one of Examples 1-9, wherein the virtualization module and the physical environment module are located on a same computing device.

Example 15 may include the subject matter of any one of Examples 1-9, wherein the computing apparatus is a selected one of a smartphone, computing tablet, ultrabook, laptop computer, e-reader, e-book, game console, or set-top box.

Example 16 is one or more computer-readable media having instructions stored thereon which, when executed by a computing device, provide the computing device with a physical environment module to: acquire, in response to a request from a virtualization module, real time data of a physical environment collected by a plurality of sensors in the physical environment, wherein the real time data includes one or more images of the physical environment; and transmit the real time data to the virtualization module for incorporation of at least a portion of the one or more images into a virtual representation of the physical environment.

Example 17 may include the subject matter of Example 16, wherein the physical environment module is further to generate a list of physical environments having real time data available and provide the list of physical environments to a virtualization module for display and selection of a physical environment from the list and wherein to acquire real time data of a physical environment is further to acquire real time data of the selected physical environment.

Example 18 may include the subject matter of Example 16, wherein the physical environment module is further to acquire previously saved data of a physical environment and transmit the previously saved data to the virtualization module for incorporation of at least a portion of the previously saved data into the virtual representation of the physical environment.

Example 19 may include the subject matter of Example 16, wherein the real time data also includes one or more of video, audio, global positioning satellite (GPS) coordinates, speed, acceleration, deceleration, lighting, temperature, or direction of travel.

Example 20 is a computer-implemented method for provisioning a virtual environment comprising: sending, by a virtualization module of a computing device, a request for real time data of a physical environment to incorporate into a virtual representation of the physical environment; receiving, by the virtualization module, the requested real time data, wherein the real time physical environment data includes one or more images of the physical environment; and generating, by the virtualization module, a virtual environment incorporating at least a portion of the one or more images.

Example 21 may include the subject matter of Example 20, wherein the virtual environment is an interactive virtual environment and further comprising: receiving, by the virtualization module, inputs of a user of the computing device; and enabling, by the virtualization module, in response to the received inputs, movement of the user in the virtual environment.

Example 22 may include the subject matter of Example 21, further comprising: requesting, by the virtualization module, additional real time data based upon the movement of the user; and regenerating, by the virtualization module, at least a portion of the virtual environment based on the additional real time data to reflect the users movement of the user in the virtual environment.

Example 23 may include the subject matter of Example 20, wherein the real time data includes one or more two dimensional (2-D) images of the physical environment and further comprising generating three-dimensional (3-D) renderings from the 2-D images and wherein generating the virtual environment incorporates at least a portion of the 3-D renderings.

Example 24 may include the subject matter of Example 23, further comprising applying, by the virtualization module, virtualized lighting conditions to the 3-D renderings.

Example 25 may include the subject matter of Example 24, wherein applying virtualized lighting conditions further comprises requesting one or more previously collected images of the physical environment reflecting the virtualized lighting condition to apply and utilizing at least a portion of the one or more previously collected images in applying the virtualized lighting condition to the 3-D renderings.

Example 26 may include the subject matter of Example 23, further comprising applying, by the virtualization module, virtualized weather conditions to the 3-D renderings.

Example 27 may include the subject matter of Example 26, wherein applying virtualized weather conditions further comprises requesting one or more previously collected images of the physical environment reflecting the virtualized weather condition to apply and utilizing at least a portion of the one or more previously collected images in applying the virtualized weather condition to the 3-D renderings.

Example 28. An apparatus for provision of a virtual environment comprising: means for sending a request for real time data of a physical environment to incorporate into a virtual representation of the physical environment; means for receiving the requested real time data, wherein the real time physical environment data includes one or more images of the physical environment; and means for generating a virtual environment incorporating at least a portion of the one or more images.

Example 29 may include the subject matter of Example 28, wherein the virtual environment is an interactive virtual environment and further comprising: means for receiving inputs of a user of the computing device; and means for enabling in response to the received inputs, movement of the user in the virtual environment.

Example 30 may include the subject matter of Example 29, further comprising: means for requesting additional real time data based upon the movement of the user; and means for regenerating at least a portion of the virtual environment based on the additional real time data to reflect the users movement of the user in the virtual environment.

Example 31 may include the subject matter of Example 30, wherein the real time data includes one or more two dimensional (2-D) images of the physical environment and further comprising means for generating three-dimensional (3-D) renderings from the 2-D images and wherein generating the virtual environment incorporates at least a portion of the 3-D renderings.

Example 32 may include the subject matter of Example 31, further comprising means for applying virtualized lighting conditions to the 3-D renderings.

Example 33 may include the subject matter of Example 30, wherein means for applying virtualized lighting conditions further comprises means for requesting one or more previously collected images of the physical environment reflecting the virtualized lighting condition to apply and means for utilizing at least a portion of the one or more previously collected images in applying the virtualized lighting condition to the 3-D images.

Example 34 may include the subject matter of Example 28, further comprising means for applying virtualized weather conditions to the 3-D renderings.

Example 35 may include the subject matter of Example 34, wherein means for applying virtualized weather conditions further comprises means for requesting one or more previously collected images of the physical environment reflecting the virtualized weather condition to apply and means for utilizing at least a portion of the one or more previously collected images in applying the virtualized weather condition to the 3-D images.

Example 36 is one or more computer-readable media having instructions stored therein, wherein the instructions, when executed by a processor of a computing device, cause the computing device to perform the method of any one of claims 19-24.

1. A computing apparatus for provision of a virtual environment comprising:
a processor;
a virtualization module operated by the processor to provide the virtual environmental for output to one or more output devices, based at least in part on real time data of a physical environment virtualized in the virtual environment; and
a physical environment module operated by the processor to receive the real time data of the physical environment for the virtualization module.

2. The computing apparatus of claim 1, wherein the virtual environment is an interactive virtual environment and the virtualization module is further to enable movement of a user in the virtual environment in response to inputs of the user received by the computing apparatus.

3. The computing apparatus of claim 2, wherein to enable movement of a user is further to enable movement of the user based upon conditions reflected in the real time data.

4. The computing apparatus of claim 3, wherein the virtualization module is to request from the physical environment module additional real time data based upon the movement of the user and the physical environment module is to acquire, in response to the request, the additional real time data, wherein the virtual environment is updated at least in part on the additional real time data.

5. The computing apparatus of claim 1, wherein the real time data includes one or more two dimensional (2-D) images of the physical environment and the virtualization module is further to generate three-dimensional (3-D) renderings from the 2-D images and wherein the virtual environment is based at least in part the 3-D renderings.

6. The computing apparatus of claim 4, wherein the virtualization module is further to apply virtualized lighting conditions to the 3-D renderings to provide a time shifted virtual environment.

7. The computing apparatus of claim 6, wherein the virtualized lighting conditions are based, at least in part, on previously collected data of the physical environment and the physical environment module is further to acquire the previously collected data for the virtualization module.

8. The computing apparatus of claim 4, wherein the virtualization module is further to apply virtualized weather conditions to the 3-D renderings to provide a time shifted virtual environment.

9. The computing apparatus of claim 8, wherein the virtualized weather conditions are based, at least in part, on previously collected data of the physical environment and the physical environment module is further to acquire the previously collected data for the virtualization module.

10. The computing apparatus of claim 1, wherein the real time data of the physical environment is collected by one or more sensors in the physical environment.

11. The computing apparatus of claim 1, wherein the real time data reflects driving conditions, boating conditions or flying conditions.

12. The computing apparatus of claim 1, wherein the real time data includes one or more of video, audio, global positioning satellite (GPS) coordinates, speed, acceleration, deceleration, lighting, temperature, or direction of travel.

13. One or more computer-readable media having instructions stored thereon which, when executed by a computing device, provide the computing device with a physical environment module to:
acquire, in response to a request from a virtualization module, real time data of a physical environment collected by a plurality of sensors in the physical environment, wherein the real time data includes one or more images of the physical environment; and
transmit the real time data to the virtualization module for incorporation of at least a portion of the one or more images into a virtual representation of the physical environment.

14. The computer-readable media of claim 13, wherein the physical environment module is further to generate a list of physical environments having real time data available and provide the list of physical environments to a virtualization module for display and selection of a physical environment from the list and wherein to acquire real time data of a physical environment is further to acquire real time data of the selected physical environment.

15. The computer-readable media of claim 13, wherein the physical environment module is further to acquire previously saved data of a physical environment and transmit the previously saved data to the virtualization module for incorporation of at least a portion of the previously saved data into the virtual representation of the physical environment.

16. The computer-readable media of claim 13, wherein the real time data also includes one or more of video, audio, global positioning satellite (GPS) coordinates, speed, acceleration, deceleration, lighting, temperature, or direction of travel.

17. A computer-implemented method for provisioning a virtual environment comprising:
sending, by a virtualization module of a computing device, a request for real time data of a physical environment to incorporate into a virtual representation of the physical environment;
receiving, by the virtualization module, the requested real time data, wherein the real time physical environment data includes one or more images of the physical environment; and
generating, by the virtualization module, a virtual environment incorporating at least a portion of the one or more images.

18. The computer-implemented method of claim 17, wherein the virtual environment is an interactive virtual environment and further comprising:
receiving, by the virtualization module, inputs of a user of the computing device; and
enabling, by the virtualization module, in response to the received inputs, movement of the user in the virtual environment.

19. The computer-implemented method of claim 18, further comprising:
requesting, by the virtualization module, additional real time data based upon the movement of the user; and
regenerating, by the virtualization module, at least a portion of the virtual environment based on the additional real time data to reflect the users movement of the user in the virtual environment.

20. The computer-implemented method of claim 17, wherein the real time data includes one or more two dimensional (2-D) images of the physical environment and further comprising generating three-dimensional (3-D) renderings from the 2-D images and wherein generating the virtual environment incorporates at least a portion of the 3-D renderings.

21. The computer-implemented method of claim 20, further comprising applying, by the virtualization module, virtualized lighting conditions or virtualized weather conditions to the 3-D renderings.

22. The computer-implemented method of claim 21, wherein applying the virtualized lighting conditions or the virtualized weather conditions further comprises requesting one or more previously collected images of the physical environment reflecting the virtualized lighting condition or the virtualized weather condition to apply, respectively, and utilizing at least a portion of the one or more previously collected images in applying the virtualized lighting condition or the virtualized weather condition, respectively, to the 3-D renderings.

23. The computing apparatus of claim 1, wherein to receive the real time data is further to acquire the real time data from the one or more sensors in the physical environment.

24. The computing apparatus of claim 1, wherein the virtualization module and the physical environment module are located on a same computing device.

25. The computing apparatus of claim 1, wherein the computing apparatus is a selected one of a smartphone, computing tablet, ultrabook, laptop computer, e-reader, e-book, game console, or set-top box.
